(19) United States
(12) Patent Application Publication
(10) Pub. No.: US 2012/0139229 A1
(43) Pub. Date: Jun. 7, 2012

(54) IDENTIFICATION LABEL, METHOD OF MANUFACTURING IDENTIFICATION LABEL, AND METHOD OF CHECKING IDENTIFICATION LABEL

(75) Inventors: Takashi Matsubara, Tokyo (JP); Akira Shirakura, Tokyo (JP); Teruaki Higashihara, Tokyo (JP)

(73) Assignees: SONY DADC CORPORATION, Tokyo (JP); SONY CORPORATION, Tokyo (JP)

(21) Appl. No.: 13/286,915

(22) Filed: Nov. 1, 2011

(30) Foreign Application Priority Data
Dec. 2, 2010 (JP) 2010-269335

(51) Int. Cl. B42D 15/00; B23P 17/04

(52) U.S. Cl. 283/70; 283/81; 29/428

(57) ABSTRACT

An identification label includes: at least one piece of identification information; and a label characteristic value used to designate a characteristic of a shape or a state. At least one piece of identification information and the label characteristic value are associated with each other.

### CROSS REFERENCES TO RELATED APPLICATIONS

The present application claims priority to Japanese Patent Application No. 2010-269335 filed on Dec. 2, 2010, the disclosure of which is incorporated herein by reference.

### BACKGROUND

The present disclosure relates to an identification label, a method of manufacturing the identification label, and a method of checking the identification label, and more particularly, to an identification label for which it can be confirmed whether an error occurs in information being recorded and a counterfeit prevention property is improved, a method of manufacturing the identification label, and a method of checking the identification label.

In order to individually identify manufactured products or the like from each other and to ensure authenticity of the products or the like, unique information (hereinafter, referred to as identification information) such as serial numbers is given to the products or the packages of the products. For example, the identification label in which the identification information is recorded is attached to a product or a package of the product in many cases.

Manufacturers or consumers can track a manufacturing process or a distribution process of a product or can confirm whether the product is authentic based on the identification information recorded in the identification label. When the product is tracked or the authenticity of the product is ensured, it is assumed that the identification information recorded in the identification label is not erroneous and the identification label is not counterfeit.

In order to ensure that the identification information is not erroneous, the manufacturer preferably confirms whether the identification information which the manufacturer intends to manufacture is certainly recorded in the identification label before the shipment of the identification label. In particular, when unique information is recorded in each label such as the identification label, it is preferably confirmed whether the identification label is regularly recorded dot by dot.

Japanese Unexamined Patent Application Publication No. 2004-133211 discloses a label production method of reliably producing labels in accordance with a production specification. However, the label production method disclosed in Japanese Unexamined Patent Application Publication No. 2004-133211 is effective when the same information is printed on all the labels, whereas it is ineffective when unique information is printed in each label. Further, a mistake can be prevented in the production of the labels. However, for example, a label in which information is not correctly printed due to a failure at the printing time may not be extracted.

In order to ensure that the identification label is not counterfeit, the identification label preferably has a high counterfeit prevention property. Here, when information is recorded in labels or the like to manufacture identification labels, a lot of methods of preventing the counterfeiting of the recorded information itself have been suggested. However, the shapes of the individual labels are the same as each other in many cases.

Japanese Unexamined Patent Application Publication No. 2010-134235 discloses a hologram label which has a plurality of corners. The shape of at least one of the plurality of corners is different from the shape of the other corners. However, when the characteristics of the shapes of the corners of the hologram label disclosed in Japanese Unexamined Patent Application Publication No. 2010-134235 are noticed, the shape of the label may be simply counterfeit. Further, since the hologram having the same design is commonly used in many goods for convenience of mass production, the hologram label disclosed in Japanese Unexamined Patent Application Publication No. 2010-134235 is not sufficient to prevent the counterfeiting of the identification label.

### SUMMARY

It is desirable to provide an identification label for which it can be confirmed whether an error occurs in information being recorded and a counterfeit prevention property is improved, a method of manufacturing the identification label, and a method of checking the identification label.

According to an embodiment of the present disclosure, there is provided an identification label including: at least one piece of identification information; and a label characteristic value used to designate a characteristic of a shape or a state. At least one piece of identification information and the label characteristic value are associated with each other.

According to another embodiment of the present disclosure, there is provided a method of manufacturing an identification label, including: forming a plurality of labels including at least one piece of identification information by trimming a label mount, in which a plurality of regions including at least one piece of identification information is set, by the use of a trimming die in which a plurality of trimming shapes is set; setting the plurality of trimming shapes to have the nearly identical shape and setting shapes or positions of small portions to be different from each other in comparison to the nearly identical shape depending on face positions; and associating at least the one piece of identification information of each label with the plurality of trimming shapes.

According to still another embodiment of the present disclosure, there is provided a method of manufacturing an identification label, including: forming a plurality of labels including at least one piece of identification information by trimming a label mount, in which a plurality of regions including at least one piece of identification information is set, by the use of a trimming die in which a plurality of nearly identical trimming shapes is set; and cutting small portions of the plurality of labels in comparison to the nearly identical shape. Shapes or positions of the cut portions are different from each other depending on face positions. At least the one piece of identification information of each label is associated with the shapes or the positions of the cut portions.

According to further still another embodiment of the present disclosure, there is provided a method of checking an identification label, which includes at least one piece of identification information and a label characteristic value for designating a shape or a state of a label and in which association is formed between at least one piece of identification information among the identification information and the label characteristic value, including confirming whether an error is present in identification information by acquiring the identification information and the label characteristic value and determining whether the association is restorable based on the acquired identification information and the acquired label characteristic value.

Here, the label characteristic value mentioned in the specification refers to information for designating the characteristics of the shape or the state of each label. In each label, a single data item may serve as the label characteristic value or a collection a plurality of data items may serve as the label characteristic value. The label characteristic value may not be present openly in the identification label. For example, the manufacturer may keep the label characteristic value. Further, the shape of the label includes not only the external shape of each label but also an unevenness shape of the surface of the label.

The label characteristic value can be determined by one kind or a plurality of kinds of combinations of the following items. In order to determine the label characteristic value, one of the external shape of the label, a relative positional relationship between the external shape of the label and the recorded identification information, the number, size, and position of an opening formed in the label or a mark pattern recorded or disposed in the label, and a dimension of the label is used or the unevenness shape of the surface of the label is used. Further, in order to determine the label characteristic value, one of luminance, hue, saturation, brightness, or diffraction efficiency is used when a birefringence, a thickness, a surface roughness, elasticity, and an illumination condition are fixed at least in a part of the label.

At least one piece of identification information is recorded in a holographic manner. The identification information recorded in the holographic manner may be recorded in a multiple manner or an image reproduced in an observation direction may be switched in a non-continuous manner or may be changed continuously.

A pattern may be recorded in the holographic manner so as to have a position and a size to the extent of not disturbing reading of the identification information recorded in the holographic manner. At this time, the form or the position or a combination of the pattern recorded in a holographic manner can be used to determine the label characteristic value. The pattern recorded in the holographic manner may be reproduced with a color different from that of the identification information recorded in the holographic manner.

At least a part of the identification information recorded in the holographic manner may be located with a depth different from that of other portions of the identification information recorded in the holographic manner. At this time, the depth of the identification information perceived when the identification label is observed can be used to determine the label characteristic value.

The plurality of labels is formed by trimming the label mount. Since a plurality of regions including at least one piece of identification information is set in the label mount, the plurality of labels including at least one piece of identification information is formed by trimming the label mount.

The plurality of trimming shapes is formed in the trimming die. The plurality of trimming shapes has the nearly identical shape and the shapes or positions of small portions are different from each in comparison to the nearly identical shape in accordance with face positions. Alternatively, the plurality of trimming shapes is formed so as to have the nearly identical shape in the trimming die. After trimming the label mount, the small portions of the plurality of labels in comparison to the nearly identical shape are cut and the shapes or positions of the cut portions are different from each other depending on the face positions. That is, the external shapes of the individual identification labels have the same shape at first glance. However, when the external shapes of the individual identification labels are observed in detail, the external shapes of the individual identification labels can be distinguished from each other. The association is formed between the identification information of each identification label and the external shape of each identification label. Further, the cutting of the label mentioned in the specification includes holing the label.

The identification label includes at least one piece of identification information and the label characteristic value for designating the characteristics of the shape or state. At least one piece of identification information among the identification information can be associated with the label characteristic value. Accordingly, it can be confirmed whether an error is present in identification information by acquiring the identification information and the label characteristic value and determining whether the association is restorable based on the acquired identification information and the acquired label characteristic value.

According to the embodiments of the present disclosure, there are provided the identification label for which it can be confirmed whether an error occurs in the information being recorded and the counterfeit prevention property is improved, the method of manufacturing the identification label, and the method of checking the identification label.

Additional features and advantages are described herein, and will be apparent from the following Detailed Description and the figures.

### BRIEF DESCRIPTION OF THE FIGURES

FIG. 1A is a plan view of an example of the configuration of an identification label according to a first embodiment.

FIG. 1B is a plan view of an example of the configuration of a collection of the identification labels formed on a label mount in multiple faces.

FIGS. 2A to 2D are plan views of another example of label characteristic values.

FIG. 3A is a schematic sectional view of an example of the configuration of a layer configuration of a hologram recording medium.

FIG. 3B is a schematic diagram of an example of an original hologram plate.

FIG. 4A is a schematic diagram for describing copying of a hologram image and recording of identification information.

FIG. 4B is a schematic diagram of an example of the configuration of identification information, which is displayed on a liquid crystal panel, to be recorded in each identification label.

FIG. 5 is a schematic diagram of an example of a configuration in which a laser beam used to copy a hologram image is set to be different from a laser beam used to record the identification information.

FIG. 6A is a schematic diagram of an example of the configuration of a trimming die which has a plurality of nearly identical trimming shapes and in which the shapes or positions are different in small portions in accordance with the face positions in comparison to the nearly identical trimming shape.

FIG. 6B is a schematic sectional view of a step of forming the external shape of a label by trimming.

FIG. 7A is a schematic diagram of an example of the configuration of a rotary trimming die.

FIG. 7B is a schematic diagram of an example of the configuration of a trimming roll by winding the rotary trimming die around the circumferential surface of the roll.

FIG. 8A is a schematic diagram of a step of forming the external shapes of the labels by rotary trimming.

FIG. 8B is a perspective view of an example of the configuration of a roll-shaped medium in which a plurality of identification labels is formed by performing trimming.

FIG. 9A is a schematic diagram of an example of the cross-sectional surface of an identification label.

FIG. 9B is a diagram of a method of using measurement conditions of an unevenness shape of the surface of the identification label as label characteristic values.

FIG. 10A is a plan view of an example of the configuration of identification labels in which the identification information and a pattern are recorded in a holographic manner.

FIG. 10B is a schematic diagram of an example of a configuration when multiple exposure is performed by changing the wavelengths of a laser beam used to record the identification information and a laser beam used to record a minute pattern.

FIG. 11 is a schematic diagram of an example of a configuration for locating at least a part of the identification information recorded in a holographic manner at a depth different from that of the other portions.

### DETAILED DESCRIPTION

Embodiments of the present application will be described below in detail with reference to the drawings.

Hereinafter, an identification label, a method of manufacturing the identification label, a method of checking the identification label will be described. The description thereof will be dame in the following order.

1. First Embodiment

2. Second Embodiment

3. Modified Examples

### 1. First Embodiment

### Identification Label

Unique information (identification information) used to specify an individual identification label is recorded in an identification label. A plurality of identification labels with the nearly identical shape is issued. Since the identification labels each have characteristics in shape or state, it is difficult to notice the characteristics at first glance. When the characteristics are confirmed using, for example, a magnifier or a microscope, the characteristics can be identified and the identification labels can be distinguished from each other based on the characteristics. Further, since label characteristic values used to designate the characteristics of the shapes or states of the identification labels can be determined, the label characteristic values can be associated with the identification information.

For example, a manufacturer of the identification labels records the identification information in a label mount on multiple faces, face positions and the identification information can be associated with each other. Further, for example, since the characteristics can be provided with the external shape of the identification label by setting a slight difference in a trimming shape from the label mount depending on the face positions, the label characteristic value can be determined from the external form of the identification label. Accordingly, the manufacturer of the identification labels can associate the identification information recorded in the labels with the shapes of the individual labels.

The manufacturer of the identification labels records the identification information in the identification labels and trims the shape from the label mount, and then confirms whether the association between the identification information and the label characteristic value can be restored. When the label characteristic value can be determined from the external characteristics of the label, for example, the identification information recorded in the label and the external shape of the label can be collectively acquired by image recognition. When the association between the identification information and the label characteristic value may not be restored, the manufacturer of the identification labels can separate the identification label, which is not restorable from the association, as a defective label. Accordingly, the manufacturer of the identification labels can confirm whether there is an error in the information recorded in the identification labels and distribute the identification labels.

Further, an observer of the identification labels confirms whether the association between the identification information and the label characteristic value can be restored on the basis of the identification information and the shape or the state of the observed identification labels. For example, it is assumed that the observer of the identification labels knows the association in which the identification label, in which odd identification information is recorded as the identification information, is necessarily rounded and chamfered in its right upper corner. At this time, when the identification information of the identification label is odd identification information and the contour shape of the identification label is not chamfered or another corner of the identification label is chamfered, the observer has reasonable doubt that the identification label is counterfeit. Accordingly, it is possible to improve the counterfeit prevention of the identification labels. Hereinafter, the identification label according to the first embodiment will be described in detail with reference to the drawings.

Label in which Identification Information is Recorded

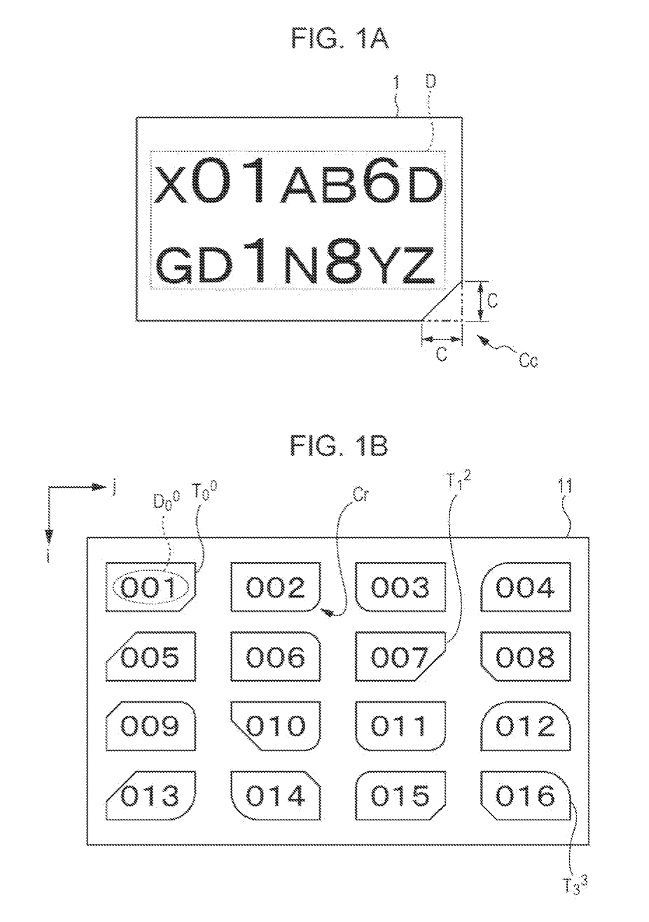

FIG. 1A is a plan view of an example of the configuration of an identification label according to the first embodiment. In the example of the configuration shown in FIG. 1A, an arrangement of characters and numerals is recorded as identification information D on the surface of an identification label 1 by printing, for example. The identification information D recorded in the identification label 1 may be identification information recorded in a holographic manner. The identification information D recorded in the identification label 1 is unique information for each label. For example, the identification label 1 is configured such that an adhesive layer is formed on the rear surface and the identification label is disposed on a separator so that the identification label can be detached from the separator and can be easily attached to a body to which the identification label is to be attached.

For example, the identification label 1 according to the first embodiment has substantially a squarish shape and has a chamfered portion Cc formed by cutting out the right lower corner in a straight shape in the example of the configuration shown in FIG. 1A. In FIGS. 1A and 1B, in order to facilitate the description, a portion having characteristics in the shape or state of the identification label, that is, the chamfered portion is illustrated in an exaggeration manner, but the actually chamfered portion does not have this size. Hereinafter, the same is applied to the other drawings.

The chamfered portions appear to have the identical shape at first glance when the plurality of identification labels is observed. However, when the observer observes the individual identification labels in detail, the chambered portions have a size to the extent that the observer can be aware of the difference between the chamfered portions. Specifically, for example, when the size of the identification label shown in FIG. 1A is 10 mm, C shown in FIG. 1A is about 0.5 mm. Further, on the assumption that the observer observes the identification label with his or her naked eyes, C shown in FIG. 1A is preferably about 0.3 mm or less.

Embodiments described below are preferred specific appropriate examples of an identification label, a method of manufacturing the identification label, and a method of checking the identification label. In the following description, various technically preferred restrictions are located, but examples of the identification label, the method of manufacturing the identification label, and the method of checking the identification label are not limited to the embodiments described below, as long as the description of the restriction on the present disclosure is otherwise made.

### Label Characteristic Value

FIG. 1B is a plan view of an example of the configuration of a collection of the identification labels formed on a label mount. For example, the identification label 1 shown in FIG. 1A can be manufactured by trimming the label mount in which the plurality of identification information is recorded on the multiple faces. FIG. 1B shows the example of the configuration in which sixteen identification labels are produced on a label mount 11 in multiple faces of 4×4 faces. Further, either the recording of the identification information and the trimming of the label mount may be performed earlier.

In the example of the configuration shown in FIG. 1B, identification information items D₀⁰ to D₃³ of sixteen identification labels T₀⁰ to T₃³ are recorded. Hereinafter, in order to distinguish the identification labels and the identification information formed on the multiple faces from each other, the face positions of the multiple faces are each designated with a row number i and a column number j. The row number i is indicated by subscript and the column number j is indicated by superscript. In FIG. 1B, for example, “007” is recorded as identification information D₁² in the identification label T₁².

In the first embodiment, the external shapes of the identification labels T₀⁰ to T₃³ are the same as each other at first glance. However, when the individual identification labels are observed in detail, the identification labels can be distinguished from each other in that the identification labels are slightly different from each other depending on the face positions. The difference between the external shapes of the identification labels can be confirmed using a magnifier or a microscope. Accordingly, since the identification labels each have a characteristic of the external shape and the label characteristic value used to designate the characteristic can be determined, the identification labels can be distinguished from each other based on the label characteristic values.

In the example of the configuration shown in FIG. 1B, the identification labels T₀⁰ to T₃³ have the characteristics in four corners. For example, the corners of the identification labels T₀⁰ to T₃³ have one of a chamfered portion (hereinafter, referred to as an R chamfered portion) cut out in a circular arc shape, a chamfered portion (hereinafter, referred to as a C chamfered portion) cut out in a straight line shape, and a right angle. The sizes of the R chamfered portion and the C chamfered portion are not limited to one kind, and a plurality of kinds of sizes can be set. For example, in the example of the configuration shown in FIG. 1B, two kinds of sizes, that is, 0.3 mm and 0.6 mm, are set as the R chamfered portion and the C chamfered portion. For example, the identification label T₀¹ has a chamfered portion Cr as the R chamfered portion in the right lower corner. The size (radius) of the R chamfered portion is set to be 0.3 mm. Table 1 below shows an example in which the face positions, the identification information, and the characteristics of the external forms of the labels of the identification labels T₀⁰ to T₃³ shown in FIG. 1B are listed.

TABLE 1

| FACE | | LABEL CHARACTERISTIC VALUE EV | | | | |
|---|---|---|---|---|---|---|
| POSITION | IDENTIFICATION | | RIGHT | LEFT | LEFT | RIGHT |
| (i, j) | INFORMATION | SHAPE OR STATE | UPPER | UPPER | LOWER | LOWER |
| (0, 0) | 001 | EXTERNAL SHAPE | — | — | — | C0.3 |
| | | OF LABEL | | | | |
| (0, 1) | 002 | EXTERNAL SHAPE | — | — | — | R0.3 |
| | | OF LABEL | | | | |
| (0, 2) | 003 | EXTERNAL SHAPE | — | — | R0.3 | — |
| | | OF LABEL | | | | |
| (0, 3) | 004 | EXTERNAL SHAPE | — | R0.6 | — | — |
| | | OF LABEL | | | | |
| (1, 0) | 005 | EXTERNAL SHAPE | — | C0.6 | — | — |
| | | OF LABEL | | | | |
| (1, 1) | 006 | EXTERNAL SHAPE | R0.3 | — | — | — |
| | | OF LABEL | | | | |
| (1, 2) | 007 | EXTERNAL SHAPE | — | — | — | C0.6 |
| | | OF LABEL | | | | |
| (1, 3) | 008 | EXTERNAL SHAPE | — | C0.3 | — | — |
| | | OF LABEL | | | | |
| (2, 0) | 009 | EXTERNAL SHAPE | R0.3 | C0.3 | — | — |
| | | OF LABEL | | | | |
| (2, 1) | 010 | EXTERNAL SHAPE | — | — | C0.6 | — |
| | | OF LABEL | | | | |
| (2, 2) | 011 | EXTERNAL SHAPE | — | — | R0.3 | R0.3 |
| | | OF LABEL | | | | |
| (2, 3) | 012 | EXTERNAL SHAPE | R0.6 | R0.6 | — | — |
| | | OF LABEL | | | | |
| (3, 0) | 013 | EXTERNAL SHAPE | — | C0.6 | — | R0.6 |
| | | OF LABEL | | | | |
| (3, 1) | 014 | EXTERNAL SHAPE | C0.3 | — | R0.6 | — |
| | | OF LABEL | | | | |
| (3, 2) | 015 | EXTERNAL SHAPE | — | R0.3 | — | C0.3 |
| | | OF LABEL | | | | |
| (3, 3) | 016 | EXTERNAL SHAPE | R0.6 | — | R0.3 | — |
| | | OF LABEL | | | | |

In Table 1, for example, “C0.3” in the column of “right lower” indicates that the right lower corner is chamfered as the C chamfered portion and the size of the chamfered portion is 0.3 mm. For example, “R0.6” in the column of “left upper” indicates that the left upper corner is chamfered as the R chamfered portion and the size of the chamfered portion is 0.6 mm. For example, “-” in the column of “left lower” indicates the left lower corner is not chamfered and the left lower corner has a right angle.

The characteristics of the shape or the state of the identification labels T₀⁰ to T₃³ can be designated depending on the external shapes of the labels and the chamfered shapes of four corners. That is, the label characteristic values EV can be determined based on the external shape of the labels and the chamfered shapes of the four corners. For example, the pairs of external shapes of the labels, shape and size of the chamfered portion of the right upper corner, shape and size of the chamfered portion of the left upper corner, shape and size of the chamfered portion of the left lower corner, and shape and size of the chamfered portion of the right lower corner can be set as the label characteristic values EV. At this time, the label characteristic values of the identification label T₁² are the external shape of the label, -, -, -, and C0.6. Further, the expression of the label characteristic values EV can be selected in any manner. For example, “R0.3” is indicated by A, “C0.3” is indicated by B, “R0.6” is indicated by C, “C0.6” is indicated by D, and “-” is indicated by E and the label characteristic values EV can be arranged in the order of the right upper corner, the left upper corner, the left lower corner, and the right lower corner. At this time, the label characteristic values EV of the identification label T₁² can be expressed to “EEED”. Therefore, the shape of each corner of the label serves as a parameter used to determine the label characteristic value EV. Thus, when the label characteristic value can be used to designate the shape or state of the individual identification label, the label characteristic value may be a pair of data items regarding each identification label or may be a single data item for the individual identification label.

In the example of the configuration shown in FIG. 1B, sixteen faces have been exemplified in order to avoid the description difficulty. However, the number of faces such as a hundred faces or two hundred faces may, of course, be increased. In the example of the configuration shown in FIG. 1B, the characteristics of the shape or the state of the identification labels are designated by the external shapes (chamfered shapes of the four corners) of the labels. At this time, when the shape of each corner is selected from one of C0.3, R0.3, C0.6, R0.6, and a right angle, there are four corners in one identification label and 5⁴=625 variations of the external shape of the identification label can be generated. Accordingly, when the chamfered shapes are used in the four corners of the identification label are used the label characteristic values and the label characteristic values are different from each other in all the face positions, correspondence of the maximum 625 faces are possible.

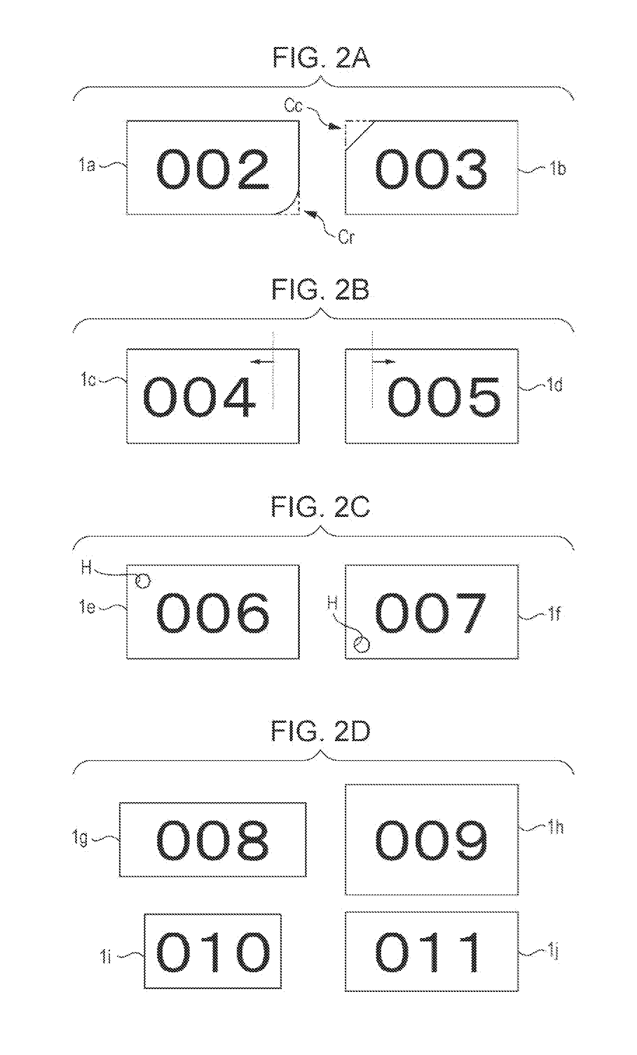

FIGS. 2A to 2D are plan views of another example of the label characteristic values.

FIG. 2A shows a modified example of the shape of the corner of the identification label, as in FIG. 1B. An identification label 1a has a chamfered portion Cr as the R chamfered portion in the right lower corner. An identification label 1b has a chambered portion Cc as the C chamfered portion in the left upper corner. The shape of each corner of the identification label can be individually formed by changing the trimming shape or partially cutting the corner, as described below. Of course, the shape of the chamfered portion is not limited to the R chamfered portion and the C chamfered portion. Further, for example, when not the so-called C chamfered portion with the size length in the horizontal and vertical directions in FIG. 1A but a chamfered portion with a length of 0.4 mm in one direction and a length of 0.2 mm in the other direction is formed, a chamfered portion with a reversed shape in the horizontal and vertical directions can be considered. Therefore, the label characteristic values can be increased. In the example of the configuration shown in FIG. 2A, pairs of positions and number of corners changed in shape and shapes and sizes of the changed corners can be used to determine the label characteristic values.

FIG. 2B shows a modified example in which the plurality of labels have the same external shape and the relative positional relationship between the external shapes of the identification labels and the recorded identification information is changed. In an identification label 1c, “004” is recorded as identification information and the recording position of the identification information is shifted left with respect to the external shape of the label. In an identification label 1d, “005” is recorded as identification information and the recording position of the identification information is shifted right with respect to the external shape of the label. By intentionally causing a printing shift at the time of recording the identification information or trimming shift at the trimming time, the relative positional relationship between the external shape of the label and the recorded identification information can be individually set. In the example of the configuration shown in FIG. 2B, pairs of shift direction and shift degree can be used to determine the label characteristic values.

FIG. 2C shows an example in which an opening is formed in the label. An identification label 1e has an opening H in the left upper corner. An identification label if has an opening H in the left lower corner. The number, size, position, and shape of the opening formed in the label can be individually set for each identification label by changing the trimming shape or partial cutting the opening, as described below. Of course, the shape of the opening is not limited to the circular shape, but the opening may be fully cut or half cut. When the identification label has a multi-layer structure, several layers may be holed. In the example of the configuration shown in FIG. 2C, the number, size, position, shape, and the like of openings formed in the labels can be used to determine the label characteristic values.

FIG. 2D shows an example in which the horizontal dimension, the vertical dimension, or both the horizontal and vertical dimensions of the rectangular label are changed. An identification label 1g is reduced in the vertical direction and is enlarged in the horizontal direction. An identification label 1h is expanded in the vertical and horizontal directions. An identification label 1i is reduced in the vertical and horizontal directions. An identification label 1j is enlarged only in the horizontal direction. The vertical dimension, the horizontal dimension, or both the vertical and horizontal dimensions of the label can be individually set for each identification label by changing the trimming shape or performing partial cutting, as described below. In the example of the configuration shown in FIG. 2D, pairs of reduction direction or expansion direction from the reference size of the label and an expansion ratio or a reduction ratio can be used determine the label characteristic values.

When the label has a rectangular external shape, some of the four sides of the rectangular external shape may be curved or a parallel angle of two facing sides may be changed, as well as the above-described example of the configuration. The characteristics of the shape or the state of the identification label may be set by appropriately combining the above-described examples of the configurations.

### Association Between Identification Information and Label Characteristic Values

The manufacturer of the identification labels can register the association between the face position (i, j) of the multiple faces and the identification information in, for example, a database when the identification information Dᵢ^{j} is recorded. The manufacturer of the identification labels can register the association between the face position (i, j) of the multiple faces and the trimming shape for the identification label in, for example, the database, when the label mount 11 is trimmed. In other words, the manufacturer of the identification labels keeps information regarding which identification information is recorded in which face position and regarding which characteristics are present in the shape or state of the identification label in which the identification information is recorded. Accordingly, in the identification labels 1, the association between the identification information and the label characteristic value is achieved. A person recording the identification information Dᵢ^{j} may be different from a person executing the trimming of the label mount. For example, the identification information and the label characteristic values may be acquired and a database may be constructed by combining shape recognition and character recognition of the identification labels 1 and performing machine-reading in the last manufacturing step.

The association between the identification information and the label characteristic values can be used to verify the identification labels 1 in, for example, a manufacturing process. For example, the manufacturer of the identification labels acquires the identification information recorded in the identification labels 1 and the external shapes of the labels as the label characteristic values by combining the shape recognition and the character recognition of the identification labels 1 and performing the machine-reading. The manufacturer of the identification labels confirms whether the pairs of identification information and label characteristic values are pairs of appropriate data by referring the acquired identification information and label characteristic values to the database in which the association between the identification information and the label characteristic values is registered.

When the association between the identification information and the label characteristic values can be restored from the acquired identification information and label characteristic values, the identification labels 1 can be verified off-line without referring to the database. For example, when the identification labels in which serial numbers are sequentially printed as the identification information in a decimal number system are manufactured on 100 faces, the label characteristic value of the identification label in which the last two digits of the serial numbers are common digits is set to be common. That is, when the identification labels in which the last two digits of the serial number are common digits have the common external shape of the labels, the identification label in which the last two digits of the serial number are identical and the external shape of the label is different can be sorted as a defective label. Even when the serial number is not expressed in a decimal number system, for example, when the identification information includes a character or a sign or the identification information is encoded, the association between information decoded from the identification information by a calculation expression or the like and the label characteristic values may be restored.

The association between the identification information and the label characteristic values can also be used, for example, when consumers determine authenticity of the identification label 1. For example, given characteristics are set in regard to the shape or state of the identification labels 1 and consumers are in advance notified of association with the identification information D. The consumers can confirm whether the association between the identification information D and the shape or state of the identification label 1 can be restored from the identification information D and the shape of state of the identification label 1, and thus can easily confirm whether the identification label 1 is counterfeit or not. Alternatively, consumers are not generally notified of the association between the identification information D and the shape or state of the identification label 1 by setting the characteristics of the shape or state of the identification labels 1 such that the characteristics are not perceived (forensic) without detail examination with a microscope or the like. A manufacturer of the counterfeit labels manufactures the identification labels with the same shape without being aware of the characteristics. However, the providers of the authentic labels can notify consumers of the characteristics of the shape or state of the identification labels 1 as authenticity determination points at an appropriate time. Thus, when the counterfeit labels are available to the consumers, the forensic effect can be obtained by notifying the consumers of the presence of the association between the identification information D and the label characteristic values EV.

### Method of Manufacturing Identification Labels

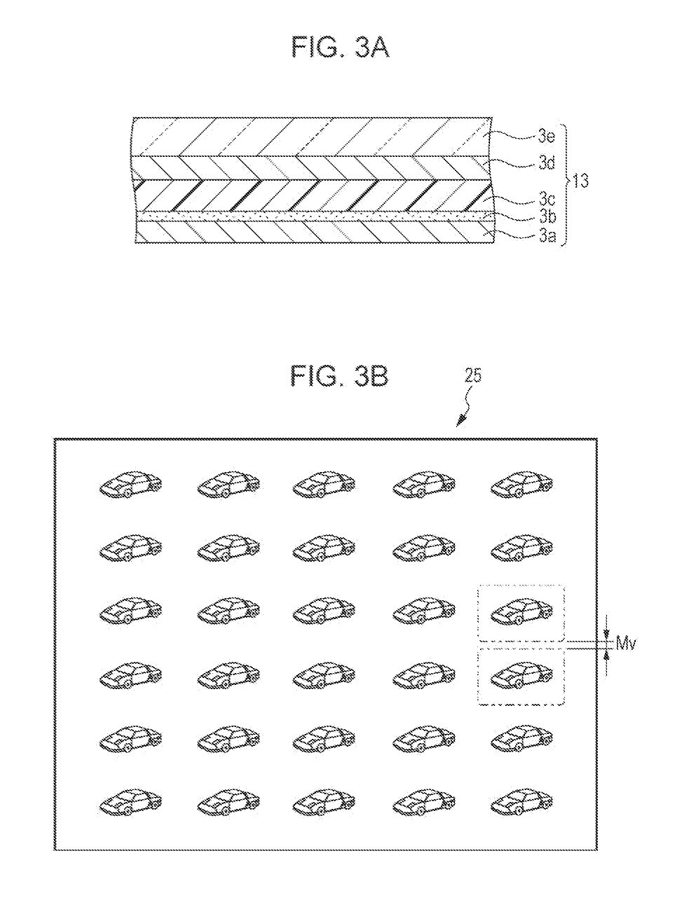

Hereinafter, a method of manufacturing the identification labels according to the first embodiment will be described with reference to FIGS. 3A to 8B. A part or the entirety of the method of manufacturing the identification labels may be performed in a roll-to-roll manner in consideration of productivity.

In the first embodiment, the plurality of labels is formed by trimming the label mount in which the plurality of regions including at least one piece of identification information is set. The plurality of trimming shapes is set in a trimming die. The plurality of trimming shapes is the nearly identical as each other and the shapes or positions of the trimming shapes are different from each other in small portions in comparison to the nearly identical shape. That is, the external shapes of the individual identification labels are the same as each other at first glance. However, when the external shapes are observed in detail, the identification labels can be distinguished from each other.

### Recording Identification Information

First, the identification information is recorded on the label mount, in which the plurality of regions where the identification information is recorded is set, on the multiple faces. The identification information is printed on the surface of the label mount by, for example, a printer apparatus. Various apparatuses such as an ink jet printer, a thermal printer, and a laser printer can be used as the apparatus printing the identification information on the label mount.

In the light of providing the authenticity determination function and the counterfeit prevention function of the identification labels, the identification information recorded in the label mount is preferably provided as identification information recorded in a holographic manner. In the holographic printing, it is preferable to use a volume-type hologram in which an interference pattern is recorded by a difference in the inner refraction index of a recording layer in that an advanced technique is necessary in the production of a recorded image and it is difficult to get a recording material. Of course, an emboss-type hologram may be applied. Hereinafter, an example will be described in which the trimming is performed on the volume-type hologram in which the identification information is recorded to manufacture the identification labels. When the identification information is recorded in a holographic manner, a hologram recording medium including a hologram recording layer is used as the label mount.

FIG. 3A is a schematic sectional view of an example of the configuration of a layer configuration of a hologram recording medium. A hologram recording medium 13 shown in FIG. 3A is a so-called film application type recording medium. As shown in FIG. 3A, for example, the hologram recording medium 13 has a configuration in which a separator sheet 3a, an adhesion layer 3b, a base layer 3c formed of a resin film, a hologram recording layer 3d formed of a photopolymerization type photopolymer, and a cover sheet 3e are laminated.

When the photopolymerization type photopolymer is used for the hologram recording layer 3d, a process can be simplified since it is not necessary to perform a special development process after exposure. In the photopolymerization type photopolymer, monomers are evenly distributed in the initial state. Therefore, when light is emitted, the monomers are polymerized in an exposure unit. The monomers are moved from the periphery as the monomers are polymerized. The density of the monomers is varied depending on a location. Accordingly, the refraction index of the photopolymerization type photopolymer is varied in accordance with incident light, and thus an interference pattern caused due to interference between reference light and object light can be recorded as the variation in the refraction index in the hologram recording layer 3d.

The hologram recording medium 13 can be supplied in a state wound in a roll shape or a sheet state. In a step of recording the identification information in a holographic manner, an image recorded in an original hologram plate 25 described below can be copied to the hologram recording medium 13 in a state where the hologram recording layer 3d and the original hologram plate 25 come into close contact with each other. In this case, the cover sheet 3e may be provided after this recording step.

The image recorded in the original hologram plate 25 is copied and the identification information is recorded in the hologram recording medium 13.

FIG. 3B is a schematic diagram of an example of the configuration of the original hologram plate. Various holograms such as a holographic stereogram, a computer-generated hologram, and a photographed hologram can be used as the original hologram plate 25. Both an HPO (Horizontal Parallax Only) type hologram having a parallax only in a horizontal direction and a FP (Full Parallax) type hologram having a parallax in both horizontal and vertical directions can be used as the holographic stereogram. As shown in FIG. 3B, image information such as a pattern, a logo of a manufacturer, or a trademark is recorded on the multiple faces on the original hologram plate 25. FIG. 3B shows an example in which a plurality of regions is set in the original hologram plate 25 and an automobile image is recorded in each region. A blank space My shown in FIG. 3B is a blank space formed in a vertical direction, as necessary. In FIG. 3B, 30 faces of 5×6 faces are illustrated, but the embodiment of the present disclosure is not limited thereto. The number of faces can be appropriately set based on the dimensions of the finished label by the manufacturer of the identification labels.

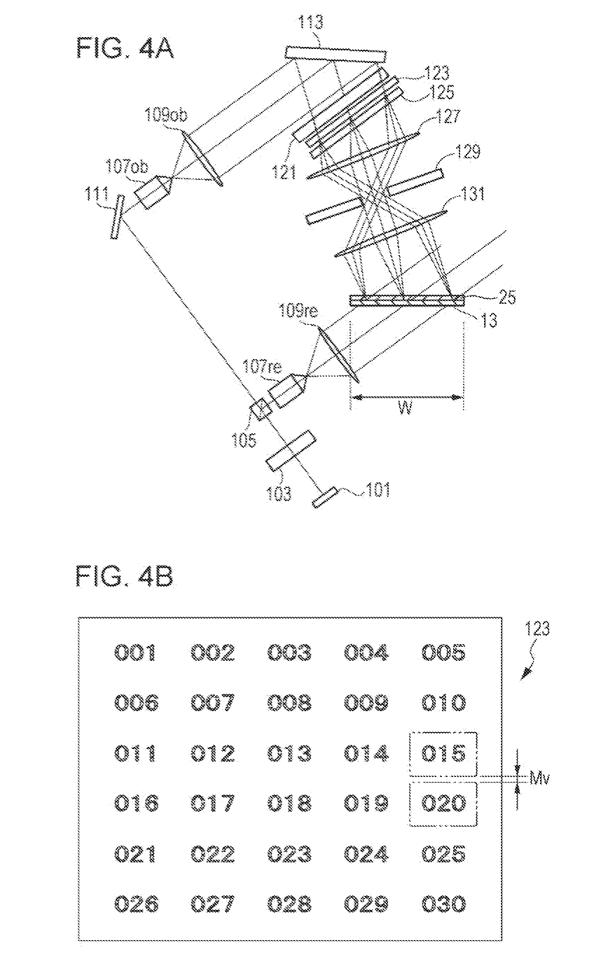

FIG. 4A is a schematic diagram for describing copying of the hologram image and recording of the identification information. In the example of the configuration shown in FIG. 4A, the copying of the image and the recording of the identification information are collectively performed on the original hologram plate 25. For example, the original hologram plate 25 shown in FIG. 4A is a holographic stereogram which has a parallax in both horizontal and vertical directions at the observation time. The hologram recording medium 13 and the original hologram plate 25 directly come into close contact with each other or come into close contact with each other with a refraction index adjustment liquid (referred to as an index matching liquid) interposed therebetween. Further, W shown in FIG. 4A indicates the width of the hologram recording medium 13 formed in an elongated shape, for example.

As shown in FIG. 4A, a laser beam from a laser beam source 101 is incident on a polarization beam splitter 105 via a half wavelength plate 103. The half wavelength plate 103 rotates the polarization surface of the laser beam by 90°. The laser beam (S polarization) is reflected from the polarization beam splitter 105 and the laser beam is expanded by a space filter 107re. The laser beam (reference beam) from the space filter 107re is incident on a collimation lens 109re. The laser beam formed as a parallel beam by the collimation lens 109re is emitted to the hologram recording medium 13 and the original hologram plate 25.

On the other hand, the laser beam passing through the polarization beam splitter 105 is reflected from a mirror 111 and is incident on a space filter 107ob. The laser beam expanded by the space filter 107ob is formed as a parallel beam by a collimation lens 109ob and is incident on a mirror 113.

The laser beam reflected from the mirror 113 is incident on a liquid crystal panel 123 serving as a space optical-modulation element via a diffuser plate 121. The diffuser plate 121 expands a viewing angle of the hologram to be copied by diffusing the laser beam from the mirror 113 at least in one of a width direction and a longitudinal direction of an element hologram of the holographic stereogram. The laser beam diffused by the diffuser plate 121 is narrowed by a diaphragm (mask) 129, as necessary, and the viewing angle is expanded only on the front side at the observation time.

Although not illustrated, a liquid crystal driving unit such as a microcomputer is connected to the liquid crystal panel 123. An image of the identification information to be recorded in each identification label is displayed on the liquid crystal panel 123 by the liquid crystal driving unit. A polarization plate 125 is installed on the exit surface of the liquid crystal panel 123. The polarization surface is rotated by the polarization plate 125 so that the laser beam incident on the hologram recording medium 13 and the original hologram plate 25 becomes an S polarized beam.

FIG. 4B is a schematic diagram of an example of the configuration of identification information, which is displayed on the liquid crystal panel, to be recorded in each identification label. As shown in FIG. 4B, the identification information to be recorded in each identification label is displayed, for example, for each of a plurality of regions corresponding to the multiple faces of the original hologram plate 25 on the liquid crystal panel 123.

A signal beam, in which the identification information generated by the liquid crystal panel 123 is superimposed, is incident on the original hologram plate 25 via an imaging optical system which includes the polarization plate 125, a projector lens 127, a diaphragm 129, and a projector lens 131. Accordingly, an interference pattern formed by a beam diffracted by the original hologram plate 25, the signal beam superimposed with the identification information and passing through the original hologram plate 25, and the reference beam (S polarized beam) is recorded in the hologram recording medium 13. That is, the automobile image and the identification information are recorded in each of the plurality of regions of the multiple faces in the hologram recording medium 13.

The laser beam used to copy the hologram image may be different from the laser beam used to record the identification information.

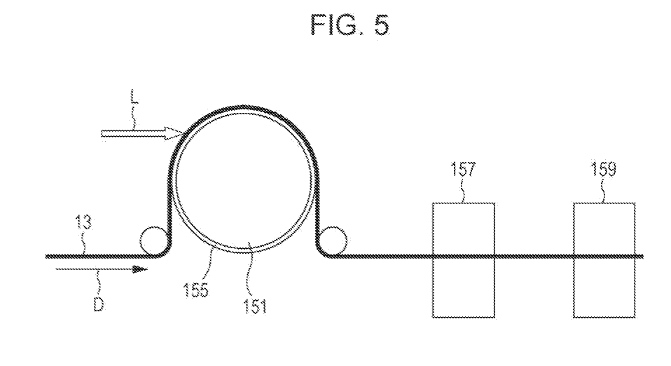

FIG. 5 is a schematic diagram of an example of a configuration in which the laser beam used to copy the hologram image is set to be different from the laser beam used to record the identification information. In the example of the configuration shown in FIG. 5, the recorded image is fixed by copying the hologram image and then recording the identification information.

As shown in FIG. 5, the hologram recording medium 13 continuously sent from a roller (not shown) so as to travel in the direction of an arrow D is wound around the circumferential surface of a roller 151. An original hologram plate 155 can be attached on the circumferential surface of the roller. A copying laser beam L is emitted in a state where the original hologram plate 155 and the hologram recording medium 13 come into close contact with each other, so that the hologram of the original hologram plate 155 is copied on the hologram recording medium 13.

The hologram is copied by sending the hologram recording medium 13. After the hologram is copied, the hologram recording medium 13 is sent to an identification information superimposing exposure unit 157 so that the identification information is recorded. The same configuration as the above-described configuration shown in FIG. 4A is applied as the configuration in which the identification information is recorded. The hologram recording medium 13, in which the hologram image is copied and the identification information is recorded, is sent from the identification information superimposing exposure unit 157 to a UV fixing unit 159. The identification information may be first recorded, the hologram of the original hologram plate 155 may be copied on the hologram recording medium 13, and then the fixing may be performed.

In the examples of the configurations shown in FIGS. 4A and 4B and FIG. 5, the hologram image is copied and the identification information is recorded. Therefore, it is possible to manufacture the identification labels in which unique information is recorded for each identification label while the main image is the same. Of course, the copying of the hologram image may not be performed. In this case, the manufactured identification label becomes a hologram seal in which only the identification information is recorded in a holographic manner.

### Forming External Shape of Label by Trimming

Next, the external shape of each identification label is formed by trimming the label mount in which the identification information is recorded.

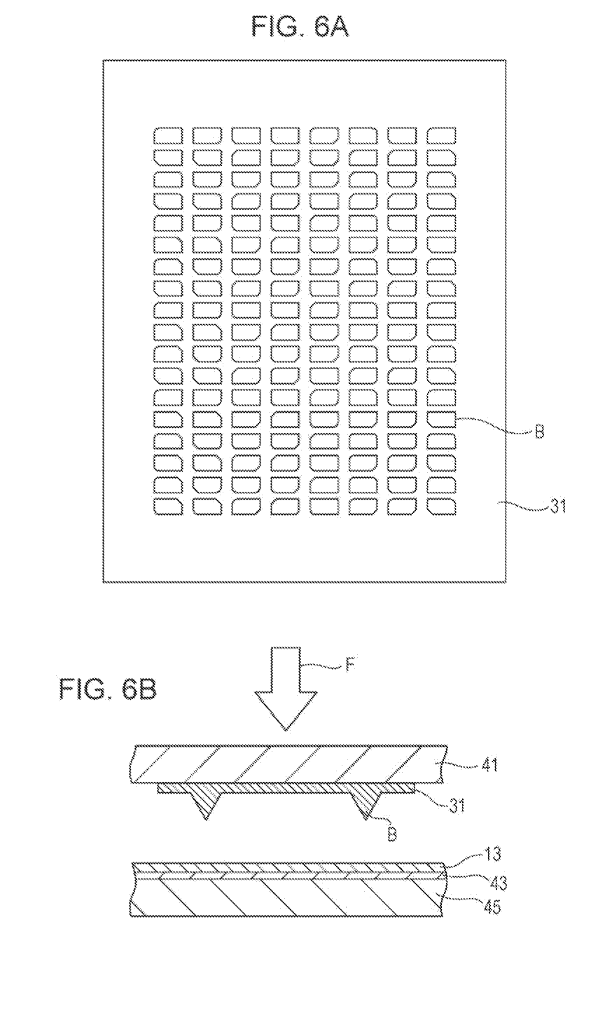

FIG. 6A is a schematic diagram of an example of the configuration of a trimming die which has a plurality of nearly identical trimming shapes and in which the shapes or positions are different in small portions in accordance with the face positions in comparison to the nearly identical trimming shape. As shown in FIG. 6A, the trimming die 31 used in the trimming of the label mount or the hologram recording medium has blades B, which are formed in the same contour as that of a shape desired to be trimmed, on one principal surface. The external shapes of the plurality of identification labels can be simultaneously formed by facing the surfaces of the blades B to the label mount or the hologram recording medium and pressing down the trimming die 31.

For example, a pinnacle type trimming die or a Thomson type (Victoria type) trimming die can be applied as the trimming die 31. The pinnacle type blade is formed by etching and is subjected to sharpening processing so that the blade edge becomes sharp, as necessary. The Thomson type blade is formed by performing groove processing on a veneer plate or a resin plate and burying an iron and steel blade bent in a groove shape. The Thomson type blade is made of an iron and steel material which contains carbon, silicon, manganese, phosphorus, sulfur as well as iron and further contains nickel, chrome, molybdenum, tungsten, vanadium, and the like.

In the example of the configuration shown in FIG. 6A, the trimming shapes of the identification labels are 8×18 faces. As shown in FIG. 6A, the trimming shapes of the identification labels are the same rectangular shape at first glance. However, when the trimming shapes of the identification labels are observed in detail, the trimming shapes of the identification labels can be distinguished from each other. For example, as in the example of the configuration of the collection of the identification labels shown in FIG. 1B, the shape of the corner of the identification label has one of the R chamfered portion, the C chamfered portion, and the right angle depending on the face position. Accordingly, by trimming the label mount or the hologram recording medium by the use of the trimming die 31, it possible to simultaneously obtain the identification labels which can be distinguished from each other due to a difference in the shape when the identification labels have the identical shape at first glance, but the identification labels are observed in detail.

FIG. 6B is a schematic sectional view of a step of forming the external shape of the label by the trimming. As shown in FIG. 6B, the trimming die 31 is fixed to a holding member 41 matching the height of the blade by an adhesive tape or the like. Further, a magnet may be used as the holding member 41 so that the trimming die 31 is fixed to the holding member 41 by a magnetic force. The holding member 41 is preferably subjected to double-sided polishing processing so that a surface to which the trimming die 31 is fixed is parallel to a surface to which a force F for pressing down the trimming die 31 against the hologram recording medium 13 is applied. As shown in FIG. 6B, the hologram recording medium 13 is disposed on a holding member 45 on which a protective member 43 is located. In a half-cut case, for example, a steel plate is used as the protective member 43. In a full-cut case, for example, a polyethyleneterephtalate or polyvinyl chloride plate is used so that the blade edge is not damaged.

By applying the force F to the trimming die 31 via the holding member 41, the trimming die 31 is pressed on the hologram recording medium 13 and a blade B cuts into the hologram recording medium 13. For example, the blade B cuts into the separator 3a to the degree of about 40% to about 50% of the height of the blade, so that the hologram recording medium 13 is cut halfway. Therefore, it is possible to simultaneously obtain the plurality of identification labels 1 with the desired trimming shapes.

As the trimming of the hologram recording medium 13, a method, which is called rotary trimming, of trimming the hologram recording medium 13 by passing hologram recording medium 13 between two rolls can be also used, as well as a so-called parallel trimming shown in FIG. 6B.

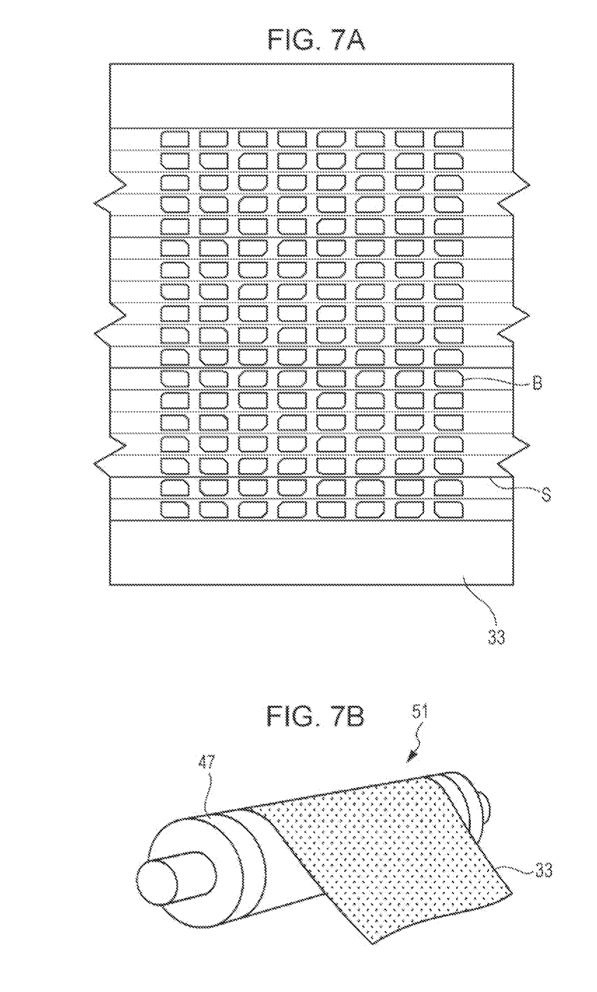

FIG. 7A is a schematic diagram of an example of the configuration of a rotary trimming die. FIG. 7B is a schematic diagram of an example of the configuration of a trimming roll by winding the rotary trimming die around the circumferential surface of the roll. A rotary trimming die 33 has the same configuration as that of the trimming die 31 for dotted trimming in that the rotary trimming die 33 includes blades B formed in the same contour shape as a desired trimming shape on one principal surface. A flexible material is selected as a material for the trimming die 33. As shown in FIG. 7B, for example, a trimming roll 51 is configured such that the trimming die 33 is wound and fixed around the circumferential surface of a magnet roll 47 with a magnetic force so that the surface on which the blades B are formed faces outside.

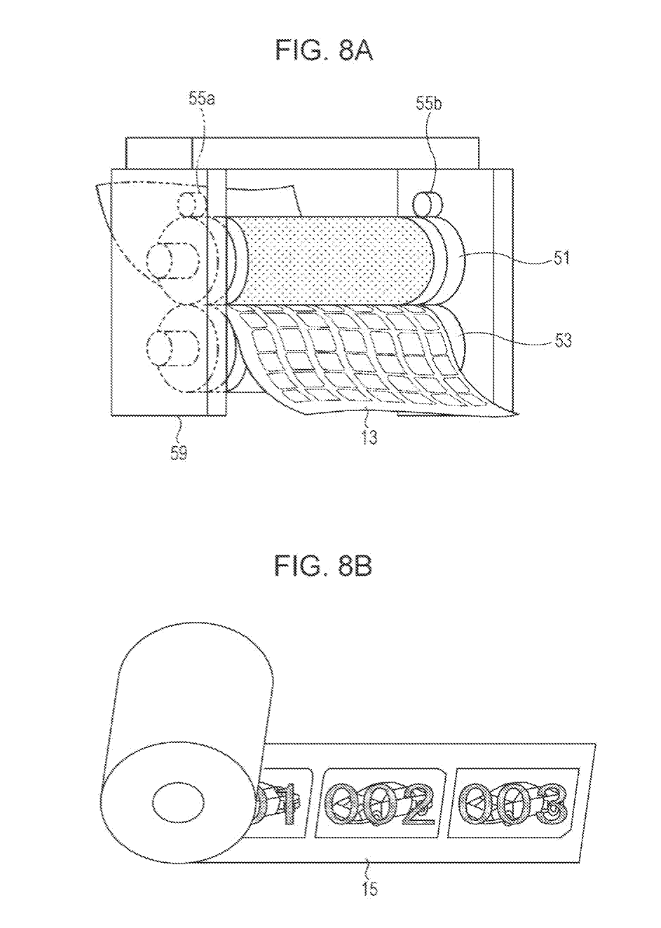

FIG. 8A is a schematic diagram of a step of forming the external shapes of the labels by the rotary trimming. FIG. 8B is a perspective view of an example of the configuration of a roll-shaped medium in which a plurality of identification labels is formed by performing trimming. As shown in FIG. 8A, a trimming roll 51 and an anvil roll 53 are disposed so that a gap of a predetermined amount is formed between the trimming roll 51 and the anvil roll 53 and are disposed in a holding member 59 so as to be rotatable. The holding member 59 includes backup rolls 55a and 55b which can adjust the disposition positions in a vertical direction. The backup rolls 55a and 55b hold the trimming roll 51 so as to come into contact with both ends of the trimming roll 51 and are disposed so that a pressurization balance is equal on the right and left sides at the trimming time.

By passing the hologram recording medium 13 between the trimming roll 51 and the anvil roll 53 while rotating the trimming roll 51 and the anvil roll 53, the hologram recording medium 13 is tightly pressed against the trimming die 33 so that the blades B cut into the hologram recording medium 13. Therefore, as in the example shown in FIG. 6B, the external shapes of the individual identification labels 1 can be simultaneously formed.

As shown in FIG. 7A, when slit-shaped blades S are formed in a direction in which the trimming die 33 is wound around the magnet roll 47, a roll-shaped medium 15 in which the plurality of identification labels 1 are formed can be produced as well, as shown in FIG. 8B.

The identification labels 1 according to the first embodiment can be obtained through the above-described processes.

When the trimming is performed a plurality of times by the parallel trimming, the identification labels having the same external shape are shown in a constant period. For example, when the identification labels are manufactured in 100 faces and the identification information is continuous serial numbers, the identification label in which a given serial number is recorded has the same external shape as the identification label in which the serial number made by adding 100 to the above serial number is recorded. Accordingly, the periodicity between the external shapes of the identification labels and the identification information can be set as one point of the authenticity determination of the identification label 1. Even when the trimming is performed by the rotary method, the identification labels having the same external shape are shown in each rotation period of the trimming roll 51. Therefore, as in the case of the parallel trimming, the periodicity between the external shapes of the identification labels and the identification information can be set as one point of the authenticity determination of the identification label 1.

Since the trimming die 31 or the trimming die 33 can be exchanged at a desired time of the manufacturer of the identification labels 1, the period between the external shape of the identification labels and the identification information can be made to be rarely found out.

For example, when the serial numbers are generated at random as the identification information, the association between the external shapes of the identification labels and the identification information can be prevented from being guessed in spite of the fact that it is noticed that the external shapes of the identification labels have the characteristics. Accordingly, it is possible to further improve the counterfeit prevention of the identification labels 1.

The manufacturer of the identification labels may keep information regarding the association between the external shapes of the identification labels and the identification information. The manufacturer of the identification labels can register the association between the face positions (i, j) of the multi faces and the identification information and the association between the face positions (i, j) of the multi faces and the trimming shapes in a database, for example. Further, the identification information and the label characteristic values may be acquired and a database may be constructed by combining shape recognition and character recognition of the identification labels 1 and performing machine-reading in the last step of the manufacture.

### Modified Example of First Embodiment

In the above-described method of forming the external shapes of the labels, the trimming is performed by the trimming die in which the plurality of nearly identical trimming shapes is provided and the shapes or positions of the trimming shapes are different from each other in small portions in comparison to the nearly identical shape. Here, after the trimming is performed using the trimming die in which the plurality of nearly identical trimming shapes are formed, the individual identification labels may be partially cut out, so that characteristics can be granted the shapes of the individual identification labels. By partially cutting out the individual identification labels in a subsequent process, the characteristics can be granted to the shapes of the individual identification labels, as shown in the identification labels 1a to 1j in FIGS. 2A to 2D. Accordingly, the examples of the configurations shown in FIGS. 2A to 2D can be applied as the label characteristic values.

### 2. Second Embodiment

In the above-described first embodiment, the label characteristic values are determined based on the external characteristics of the identification labels. However, an unevenness shape of the surface of each identification label or the physical characteristics of the identification label can be used to determine the label characteristic values.

Identification information used to specify an individual identification label is recorded in the identification label. The unevenness shape of the surface of the identification label or the physical characteristics of the identification label is measured for the issued individual identification. The individual identification labels have the same external shape at first glance. However, when the identification labels are measured by an image inspector or a measurement tool measuring the physical characteristics, pairs of measurement conditions and measured values serve as unique information of the individual identification label. For example, the label characteristic values can be determined by using, as parameters, the pairs of measurement conditions of the unevenness shape of the surface of the identification label or the physical characteristics of the identification label and measured values. The label characteristic values can be associated with the identification information.

For example, after the manufacturer of the identification labels performs the trimming on the label mount or the hologram recording medium, the manufacturer of the identification labels measures the unevenness shapes of the surfaces of the identification labels or the physical characteristics of the identification labels at the specific positions of the individual identification labels and registers information regarding the measurement conditions and the measured values in a database. The measurement details and the measurement conditions of the individual identification labels can be determined in accordance with the identification information. Accordingly, the manufacturer of the identification labels can associate the identification information recorded in the labels with the unevenness shapes of the surfaces of the individual identification labels or the physical characteristics of the individual identification labels.

### Example of Determining Label Characteristic Value Based on Unevenness Shape of Surface of Identification Label

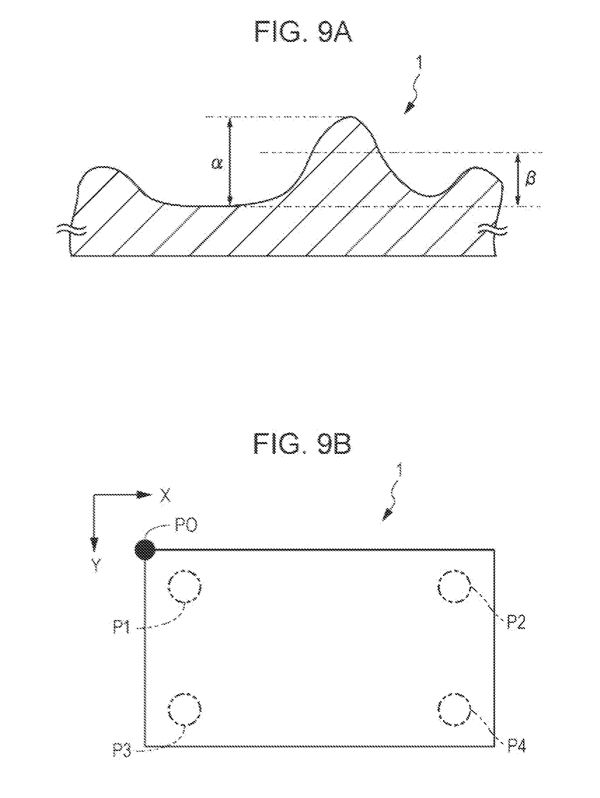

FIG. 9A is a schematic diagram of an example of the cross-sectional surface of an identification label. FIG. 9B is a diagram of a method of using measurement conditions of the surface of the identification label as the label characteristic values. As shown in FIG. 9A, for example, the identification label 1 generally has an unevenness shape on the surface thereof. For example, when the identification information is an identification label recorded in a holographic manner, the unevenness shape of the surface of the cover sheet 3e becomes the unevenness shape of the surface of the identification label 1. Therefore, when a region on the surface of the identification label 1 is set and the unevenness shape in the region is digitalized, the result can be used as the characteristic of the shape of the identification label. That is, the label characteristic value can be determined based on the unevenness shape of the surface of the individual identification label. For example, the number of concave portions or convex portions in a specific region, a difference between the heights (indicated by α in FIG. 9A) of the concave portion and the convex portion, an average height (indicated by β in FIG. 9A) from the lowest portion of the concave portion to the summit of the convex portion, or the like can be used as the label characteristic value.

At this time, the measurement condition of the unevenness shape of the surface of the identification label, for example, a measurement position or a measurement area can be used to determine the label characteristic value. In an example shown in FIG. 9B, P1 to P4 are set as positions used to measure the unevenness shape of the surface of the identification label. For example, the measurement positions P1 to P4 can be set as a pair of a distance X in the horizontal direction and a distance Y in the vertical direction by setting the left upper corner of the individual identification label as the origin PO. The manufacturer of the identification labels 1 can designate one of the measurement positions P1 to P4 of the identification labels, in which the continuous serial numbers are recorded as the identification information, to perform the measurement in accordance with the recorded serial numbers. For example, the manufacturer of the identification labels 1 can designate, as the label characteristic values, the measured values at the measurement positions P1 of the identification labels in the range of the serial numbers 100 to 200. That is, the identification information is associated with the measured values as the label characteristic values. Further, the number of measurement points or the measurement area where the designated measurement position is set as a center can be also designated in accordance with the serial number.

Table 2 below shows an example in which the identification information is associated with the label characteristic values when the label characteristic values are determined based on the unevenness shape of the surface of the identification label 1.

TABLE 2

| | | | | | | LABEL |
|---|---|---|---|---|---|---|
| | | | | | | CHARACTERISTIC |
| | | | | | | VALUE EV |
| | PARAMETERS | | | | | MEASURED |
| | NUMBER OF | | | | | VALUE |
| IDENTIFICATION | MEASUREMENT | MEASUREMENT | | MEASUREMENT | MEASUREMENT | (MAXIMUM |
| INFORMATION | POINTS | POSITION | | AREA | CONTENTS | VALUE) |
| 0001 | 1 | P1 | — | 2 mm | α | 0.30 |
| 0002 | 2 | P2 | P4 | 1 mm | β | 0.12 |
| 0003 | 1 | P2 | — | 2 mm | β | 0.11 |
| 0004 | 2 | P1 | P3 | 3 mm | α | 0.42 |
| . . . | . . . | . . . | . . . | . . . | . . . | . . . |

In the example shown in Table 2, the measured values of the unevenness shapes of the surfaces of the identification labels 1 are set as the label characteristic values EV. The number of measurement points, the measurement areas, and the measurement contents serve as parameters used to determine the label characteristic values EV. For example, in the identification label in which the identification information “002” recorded, an average height 13 from the lowest portion of the concave portion to the summit of the convex portion is measured at two measurement positions P2 and P4 when the measurement area is 1 mm. The larger measured value “0.12” between the measured two heights 13 becomes the label characteristic value EV associated with the identification information “002.” Further, pairs of data regarding the number of measurement points, the measurement positions, the measurement areas, measurement contents, and the measured values may be set as the label characteristic values.

The identification information may be associated with the label characteristic values after the individual labels 1 are manufactured. For example, a database collecting the identification information and the measurement conditions is prepared in advance. The measurement values can be additionally registered in the database by performing machine reading on the identification information of the individual identification labels by character recognition, referring the acquired identification information to the database, and performing the measurement under the designated measurement conditions. When the identification information itself is associated with the measured, the authenticity of the identification labels 1 can be determined off-line without referring to the database.

### Example of Determining Label Characteristic Value Based on Physical Characteristic of Identification Label

In the above-described example, the label characteristic value can be determined based on the unevenness shape of the surface of the identification label. However, the label characteristic value may be determined based on the physical characteristics of the identification label. For example, the label characteristic value can be determined based on luminance, hue, saturation, brightness, or diffraction efficiency, or the like, when a birefringence, a thickness, a surface roughness, a coefficient of elasticity, and an illumination condition are fixed as the measurement contents.

Table 3 below shows an example of the database collecting the measurement positions and the measurement contents when the label characteristic values are determined based on the physical characteristics of the identification labels.

TABLE 3

| | MEASUREMENT | | |
|---|---|---|---|
| IDENTIFICATION | POSITION | | MEASUREMENT |
| INFORMATION | X | Y | CONTENTS |
| 001-010 | 1.0 mm | 1.0 mm | BIREFRINGENCE |
| 011-020 | 1.0 mm | 4.0 mm | SURFACE |
| | | | ROUGHNESS |
| 021-030 | 4.0 mm | 1.0 mm | THICKNESS |
| 031-040 | 4.0 mm | 4.0 mm | BIREFRINGENCE |
| . . . | . . . | . . . | . . . |

The plurality of measurement positions or measurement conditions may be combined for the individual identification labels. Alternatively, as shown in Table 3, the measurement position and the measurement contents may be changed in accordance with the identification information. Of course, the same measurement conditions may be set for all the identification labels.

When the unevenness shape of the surface of the identification label or the physical characteristic of the identification label is used as information used to determine the label characteristic values, the unevenness shape or the physical characteristic is not preferably changed over time. However, even when the unevenness shape or the physical characteristic is changed over time, a temporal change amount of the unevenness shape or the physical characteristic can be used as information used to determine the label characteristic value in a case where the temporal change can be expressed by a simple function and the change ratio is taken into consideration.

### 3. Modified Examples

Hitherto, the preferred embodiments have been described, but the preferred specific examples are not limited to the above description.

For example, in the above-described embodiment, the example has been described in which the association is formed between the characteristics of the shapes of the individual identification labels and the identification information recorded in the holographic manner by using the hologram recording medium as the label mount. The identification information can be association with information other than the characteristics of the shapes of the identification labels.

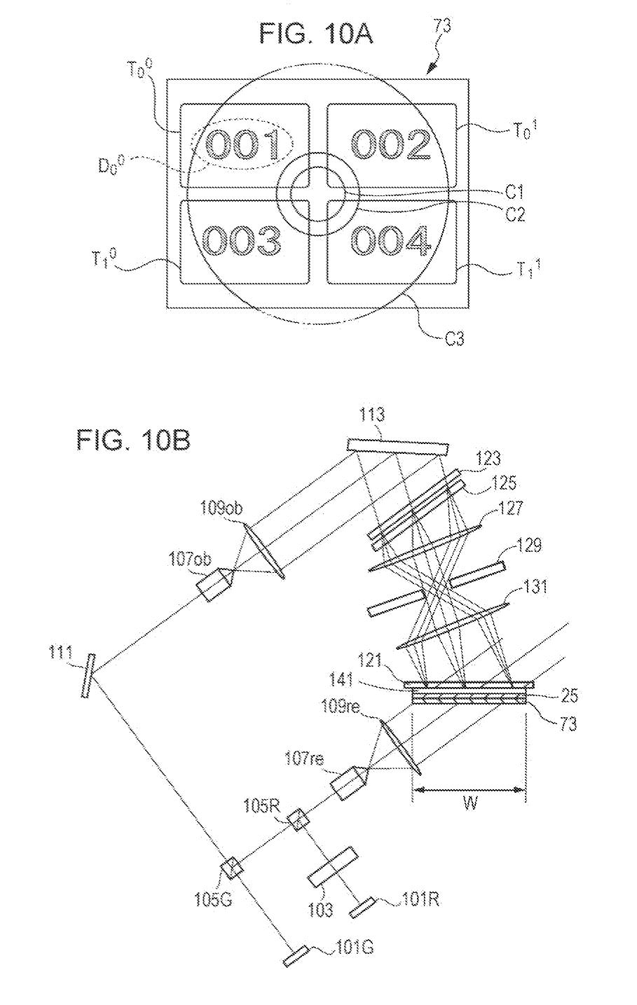

FIG. 10A is a plan view of an example of the configuration of identification labels in which the identification information and the pattern are recorded in a holographic manner. In a hologram recording medium 73 shown in FIG. 10A, identification labels T₀⁰ to T₁¹ in which identification information D₀⁰ to D₁¹ are recorded, respectively, are formed in four faces. Further, circular shapes C1 to C3 are recorded on the entire surface of the hologram recording medium 73 in all the identification labels T₀⁰ to T₁¹ in a holographic manner. In the example of the configuration shown in FIG. 10A, the forms confirmed when the individual identification labels are separated are different from each other in accordance with the face positions of the identification labels T₀⁰ to T₁¹. Accordingly, by recording the pattern on the entire surface of the hologram recording medium of the multiple faces, the form of the pattern in accordance with the face positions can be associated with the identification information as the label characteristic value.

Further, it is preferable to record the pattern recorded in the hologram recording medium so as to have a position and a size to the extent of not disturbing reading of the identification information recorded in the holographic manner. It is preferable to form a minute pattern such that the pattern recorded in the hologram recording medium of the multiple faces is not perceived at first glance but the identification labels can be distinguished from each other when observed in detail to the extent of not disturbing the reading of the identification information. Further, it is preferable to record the minute pattern at a position at which the reading of the identification information recorded in the holographic manner is not disturbed. In this way, the form, position, or size of the pattern or a combination of the form, position, or size of the pattern recorded in the holographic manner in accordance with the face positions can be associated as the label characteristic value with the identification information.

The minute pattern recorded in the holographic manner may not be necessarily a pattern formed intentionally. For example, when a flaw or the like is present at a specific location of the original hologram plate used to copy a hologram, a hologram image of the flow on the original hologram plate is shown at the specific location of the hologram recording medium at the time of copying the hologram. That is, the hologram image with the flaw on the original hologram plate is necessarily recorded on the specific surface of the multiple faces. When the face position at which the hologram image with the flaw appears is specified, the manufacturer of the identification labels can associate the form, position, or size of the hologram image with the flaw as the label characteristic value with the identification information.

One or more marks confirmable by an illumination condition may be recorded in the identification labels by printing or the like. It may not be confirmed which mark is printed under a normal fluorescent or sunlight, but a mark confirmable by the illumination condition can be realized by printing using, for example, photochromic ink. For example, the photochromic ink is ink producing color when ultraviolet light is emitted or ink absorbing or reflecting infrared light. In this case, a counterfeit prevention function can be granted to the identification labels by associating the number, position, size, or the like of a concealed mark as the label characteristic value with the identification information.

A color tinge perceived at the time of observing the minute pattern recorded in the holographic manner is preferably a color tinge different from a color tinge perceived at the time of observing the identification information recorded in the holographic manner in terms of not disturbing the reading of the identification information. For example, a color tinge perceived at the time of observing the identification information recorded in the holographic manner is preferably a green-tinged color and the color tinge perceived at the time of observing the minute pattern recorded in the holographic manner is preferably a red-tinged color. A plurality of methods of changing the hologram colors of the identification information and the minute pattern can be used.

FIG. 10B is a schematic diagram of an example of a configuration when multiple exposure is performed by changing the wavelengths of a laser beam used to record the identification information and a laser beam used to record a minute pattern. In the example of the configuration shown in FIG. 10B, for example, a red laser beam source 101R and a green laser beam source 101G are installed to record the minute pattern and the identification information, respectively.

A red laser beam emitted from the red laser beam source 101R is incident on a polarization beam splitter 105R via the half wavelength plate 103. A green laser beam emitted from the green laser beam source 101G and separated by a polarization beam splitter 105R is also incident on the polarization beam splitter 105R. The read laser beam and the green laser beam are synthesized by the polarization beam splitter 105R so as to be incident on the space filter 107re. The laser beam from the space filter 107re becomes parallel light through the collimation lens 109re and is emitted to the hologram recording medium 73 and the original hologram plate 25. On the original hologram plate 25, for example, a minute pattern with different positions and sizes for every face position of the multiple faces is recorded as a hologram.

The green laser beam passing through the polarization beam splitter 105R is reflected from the mirror 111 and is incident on the space filter 107ob. The laser beam expanded by the space filter 107ob is incident on the mirror 113 via the collimation lens 109ob. The laser beam reflected from the mirror 113 is incident on the liquid crystal panel 123 serving as a space optical-modulation element. The polarization plate 125 is installed on the exit surface of the liquid crystal panel 123, so that the polarization surface of the green laser beam is rotated by the polarization plate 125.

In the example of the configuration shown in FIG. 10B, the diffuser plate 121 is disposed on the side in which the beam from the projector lens 131 is incident on the original hologram plate 25. Further, in the example of the configuration shown in FIG. 10B, a louver 141 is disposed between the diffuser plate 121 and the original hologram plate 25. The louver 141 is installed to prevent an unnecessary beam such as a reflected beam from being incident on the original hologram plate 25.

An interference pattern formed by a beam diffracted by the original hologram plate 25, the signal beam superimposed with the identification information and passing through the original hologram plate 25, and the reference beam is recorded in the hologram recording medium 73. That is, in the hologram recording medium 73, the red minute pattern and the green identification information can be recorded for each of the plurality of regions of the multiple faces. The red minute pattern and the green identification information may be simultaneously recorded or may be recorded in a time sequence.

Not only the position or size of the pattern recorded in the holographic manner apart from the identification information is used as the label characteristic value, but also at least a part of the identification information recorded in the holographic manner may be located at a depth different from that of another portion in accordance with the face positions of the multiple faces. For example, when a serial number is recorded as the identification information in a holographic manner, only a numeral of a specific digit may be viewed at a depth different from that of a numeral of another digit. Accordingly, information regarding a numeral of a given digit viewed at a depth different from that of a numeral of another digit can be used as the label characteristic value.

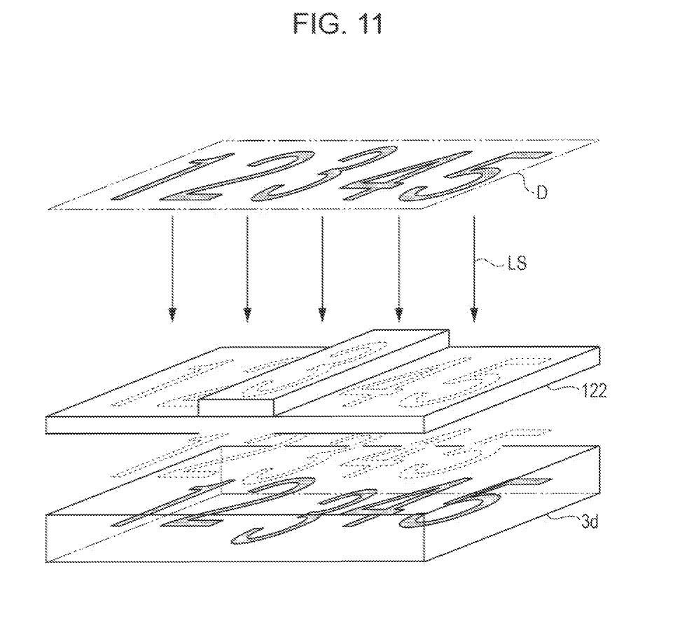

FIG. 11 is a schematic diagram of an example of a configuration for locating at least a part of the identification information recorded in a holographic manner at a depth different from that of the other portions. For example, the configuration shown in FIG. 4A or 10B can be used as a configuration in which the identification information D is recorded on the multiple faces in the hologram recording medium. Here, the depth at which the identification information D is located can be set freely in accordance with image processing or the position of the diffuser plate 121. Accordingly, for example, at least a part of the identification information D recorded in the holographic manner can be located at a depth different from that of another portion by allowing the distances between the hologram recording medium 73 and parts of the diffuser plate 121 to be different from each other.

In the example of the configuration shown in FIG. 11, for example, the identification information D is recorded in the hologram recording layer 3d by locating only a numeral “3” of the third digit at a depth different from the depths of the other numerals with respect to a signal beam LS in which numeral arrangement of “12345” is superimposed as the identification information D. In FIG. 11, in order to facilitate description, only the diffuser plate 122 and the hologram recording layer 3d are illustrated and the imaging lens and the like are not illustrated. The shape of the diffuser plate 122 is illustrated in an exaggeration manner.

As shown in FIG. 11, the diffuser plate 122 is configured such that the distance between the diffuser plate 122 and the hologram recording layer 3d is larger at a portion corresponding to the numeral “3” of the third digit in the signal light LS passing through the diffuser plate 122. Thus, only the numeral “3” of the third digit is located at a depth different from the depths of the other numerals so as to be recorded in the hologram recording layer 3d. That is, when the identification label including the hologram recording layer 3d is observed, only the numeral “3” of the third digit among “12345” recorded as the identification information D is perceived at a position deeper than the positions of the other numerals. Accordingly, the identification information D can be simultaneously recorded on the multiple faces, for example, by locating at least a part of the identification information D at a depth different from the depths of the other portions by the use of the diffuser plate 122 which does not have a flat shape but has an unevenness shape.

In the above-described configuration, the information regarding a numeral of a given digit viewed at a depth different from the depths of numerals of the other digits can be associated as the label characteristic value with the identification information D. For example, when the digit of a numeral viewed at a depth different from the depths of the other numerals is identical with the last numeral of numerals obtained by multiplying all of the numerals of a serial number, the association can be used as an authenticity point of the identification label.

Further, when the identification information is recorded in the holographic manner and the form, position, size of the pattern recorded in the holographic manner or the depth of the identification information are sued as the label characteristic values apart from the identification information, the characteristics of the shape of the identification label may not be so important.

Hitherto, the preferred embodiments and the modified examples have been described, but appropriate specific examples are not limited to the above-described embodiments and modified example. Instead, the above-described configurations may be appropriately combined.

For example, in the first and second embodiments described above, the external of the identification label 1 is set to be rectangular, but may be polygonal, circular, or the like. The shape of the identification label is not limited. The material of the identification label 1 may be selected from cloth, metal, glass, ceramics, resin, or the like. The material of the identification label 1 is not limited to a specific material.

For example, the identification label 1 has the configuration in which the identification label is detached from a separator and is easily attached to a body to which the identification label is to be attached, but embodiments of the present disclosure is not limited thereto. Instead, the identification label 1 may include another functional layer or may be configured as a tag to be attached to a product.

For example, in the first embodiment, the example has been described in which the hologram of the original hologram plate is copied to the hologram recording medium. However, the identification information may be recorded in the hologram recording medium, in which a hologram is recorded in advance, in a holographic manner and the trimming may be performed. Further, the method of forming the external shapes of the identification labels is not limited to the trimming. Instead, the external shapes of the identification labels may, of course, be cut halfway or fully.

For example, in the second embodiment, the example has been described in which the unevenness shape of the surface of the individual identification label or the physical characteristics of the identification label are used as the label characteristic values. Instead, the individual identification labels are manufactured and processing or deformation is further performed, and then the unevenness shape of the surface or the physical characteristics of the identification label may be further granted later. Further, before the shipment of the identification labels, the unevenness shape of the surface or the physical characteristics of the identification label may be measured at any time.

For example, a parity checking function may be added as the label characteristic value.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An identification label comprising:
at least one piece of identification information; and
a label characteristic value used to designate a characteristic of a shape or a state,
wherein at least one piece of identification information and the label characteristic value are associated with each other.

2. The identification label according to claim 1, wherein the label characteristic value is determined based on one of an external shape of a label, a relative positional relationship between the external shape of the label and the recorded identification information, the number, size, and position of an opening formed in the label, and a dimension of the label or a combination thereof.

3. The identification label according to claim 1, wherein the label characteristic value is determined based on an unevenness shape of a label surface.

4. The identification label according to claim 1, wherein the label characteristic value is determined based on one of luminance, hue, saturation, brightness, and diffraction efficiency or a combination thereof, when a birefringence, a thickness, a surface roughness, a coefficient of elasticity, and an illumination condition are fixed at least in a part of the label.

5. The identification label according to claim 2, wherein at least one piece of identification information is recorded in a holographic manner.

6. The identification label according to claim 5, wherein a pattern is recorded in the holographic manner so as to have a position and a size to the extent of not disturbing reading of the identification information recorded in the holographic manner.

7. The identification label according to claim 5 wherein at least a part of the identification information recorded in the holographic manner is located with a depth different from that of other portions of the identification information recorded in the holographic manner.

8. The identification label according to claim 1,
wherein at least one piece of identification information is recorded in a holographic manner,
wherein a pattern with a position and size to the extent of not disturbing reading of the identification information recorded in the holographic manner is further recorded in the holographic manner, and
wherein the label characteristic value is able to be determined based on a form, a position, or a size of the pattern or a combination thereof.

9. The identification label according to claim 1,
wherein at least one piece of identification information is recorded in a holographic manner,
wherein at least a part of the identification information recorded in the holographic manner is located with a depth different from that of other portions of the identification information recorded in the holographic manner, and
wherein the label characteristic value is able to be determined based on information regarding a given portion viewed at a depth different from that of another portion in the identification information recorded in the holographic manner.

10. A method of manufacturing an identification label, comprising:
forming a plurality of labels including at least one piece of identification information by trimming a label mount, in which a plurality of regions including at least one piece of identification information is set, by the use of a trimming die in which a plurality of trimming shapes is set;
setting the plurality of trimming shapes to have the nearly identical shape and setting shapes or positions of small portions to be different from each other in comparison to the nearly identical shape depending on face positions; and
associating at least the one piece of identification information of each label with the plurality of trimming shapes.

11. A method of manufacturing an identification label, comprising:
forming a plurality of labels including at least one piece of identification information by trimming a label mount, in which a plurality of regions including at least one piece of identification information is set, by the use of a trimming die in which a plurality of nearly identical trimming shapes is set; and
cutting small portions of the plurality of labels in comparison to the nearly identical shape,
wherein shapes or positions of the cut portions are different from each other depending on face positions, and
wherein at least the one piece of identification information of each label is associated with the shapes or the positions of the cut portions.

12. A method of checking an identification label, which includes at least one piece of identification information and a label characteristic value for designating a shape or a state of a label and in which association is formed between at least one piece of identification information among the identification information and the label characteristic value, the method comprising:
confirming whether an error is present in identification information by acquiring the identification information and the label characteristic value and determining whether the association is restorable based on the acquired identification information and the acquired label characteristic value.
